(19) United States
(12) Patent Application Publication
(10) Pub. No.: US 2005/0083195 A1
(43) Pub. Date: Apr. 21, 2005

(54) Disguised personal security system in a mobile communications device

(76) Inventors: Luc H. Pham, Charlotte, NC (US); Quang H. Pham, Charlotte, NC (US)

Correspondence Address: Luc H. Pham, 617 Kingman Drive, Charlotte, NC, 28217, US

(21) Appl. No.: 10/967,366

(22) Filed: Oct. 16, 2004

Related U.S. Application Data
(60) Provisional application No. 60/511,317, filed on Oct. 16, 2003.

(51) Int. Cl. G08B 1/08

(52) U.S. Cl. 340/539.13; 340/573.1; 340/574; 455/404.2

(57) ABSTRACT

The disguised personal security system in a mobile communications device (MCD) has two modes of operations: audible and silent. Depend on the situation, the user may activate an audible alarm to fend off the perpetrator or in hostile situation, secretly contacts an emergency monitoring service (EMS). The system may be activated manually or automatically. When activated, the MCD contacts an EMS and transmit its location coordinates. The EMS then transmits an acknowledgement signal and activates a “hyper-state” microphone to monitor the user's environment and dispatches the corresponding assistance or authorities. The disguised personal security system is seamlessly integrated into a mobile communication device so that close scrutiny of the device will not be able to distinguish it as a personal security system. The system includes hidden setup menus that accessible by the secret key sequence.

### CROSS-REFERENCE TO RELATED APPLICATION

This application claims the benefit of U.S. Provisional Patent Application Ser. No. 60/511,317, filed Oct. 16, 2003.

### BACKGROUND OF THE INVENTION

1. Field of the Invention

The present invention relates to a personal alarm system with Global Positioning System (GPS) and wireless communication, and particularly to the integration of personal alarm system into a mobile communications device (MCD).

2. Description of Related Art

Various personal alarm systems currently available reflect modern society's perceived need for devices which protect the individual from assaults, abductions, rapes and other life threatening events. The number and variety of such devices also reflect that no single device has been found satisfactory for the achievement of preventing and assisting individual in such emergencies. The present invention is directed towards an advanced disguised personal security system to provide maximum protection and assistance for various individuals in emergency situations. Over the past decades, violent crimes against the individuals have risen at startling rates. In response to the high crime rates, personal alarm systems were introduced. Over the years, personal alarm systems have undergone many enhancements as technology progressed. Personal alarm systems range from the primitive push-button siren to advanced GPS equipped systems. However, the available systems still have disadvantages when compared with the instant invention. These systems vary in complexity and features, such as a simple mace may be used to deter rapists and an automated event detection alarm system utilizing mobile communications networks. With the stagnant economy, crime rates are expected to experience a high rise putting the individuals at more risks of assaults, robbery, rapes and in some case deaths. Unfortunately, personal tragedies often dominate national headlines and television news. They often report of missing, rape, assault victims and often of their tragic ends. In these tragedies, possessing an efficient emergency locator may have ensured the individuals their safety.

The present invention is a disguised personal security system which includes a mobile communications device (MCD), a location transceiver and a wireless transmitter. Upon activation by either the wireless trigger, or manual trigger or sensors input, the MCD contacts an emergency monitoring service (EMS) by dialing the preprogrammed telephone number to transmit the emergency events. The MCD transmits a signal with the individual's information such as subscriber number and geo coordinates. Upon receiving the emergency signal, the EMS transmits an acknowledgement signal to the MCD. The EMS then establishes a one-way communication to listen to the individual's situation to verify it is safe to establish a two-way communication then contact the proper assistance or authority such as police, fire department, paramedics and the likes.

Security system such as silent alarms are used in common places such as banks, restaurants, grocery stores, gas stations, etc. . . . Typically, silent alarms are used to secretly contact the authorities in the event of a bank robbery without exacerbating the situation. The broad applications of silent alarms directly reflect society's needs and acceptance of such security system. Essentially, the instant invention is a silent alarm integrated into a mobile communications device (MCD).

Mobile security systems have been in use for many years. With the advent to communications technology, personal alarm devices (PAD) are often equipped with the ability to convey its geographical location. Generally, global positioning system (GPS) and its variations are utilized as reliable locating methods. Usually, differential global positioning system (DGPS) and other proprietary methods are more accurate than the standard GPS. Typically, a mobile personal security system (MPSS) consists of a MCD with access to a cellular communications network (CCN), an emergency monitoring service (EMS) and a dispatch center. MPSS vary in functions but generally serve the common purpose of transmitting an individual's emergency request to receive proper assistance in time.

While these devices may be suitable for the particular purpose to which they address, they are not as suitable during aggravated (duress) situations and like most emergency situations timing is very important to the individual's safety and wellbeing. A common problem with conventional MPSS is false signals. False signals are highly common in automated MPSS. Due to the nature of their designs, they are prone to produce false alarms. False signals of MPSS will not only waste invaluable resources such as police and paramedics but also minimize the individual's chances of being rescued by slowing down response times. Another major flaw is that personal alarm systems are easily recognizable. In a kidnap situation, for example, the perpetrator can easily recognize the alarm system and quickly discard it to prevent tracking, even if it has successfully transmitted its geo coordinates. In hostile situations, it is preferred not to exacerbate the ordeal by explicitly activating such personal security system. Again, the wide availability of silent alarm systems reflects society's need of such method of secretly contacting local authority. Over the years, many improvements have been made to personal security systems.

U.S. Pat. No. 4,510,350, issued to Wagner et al. discloses a personal alarm apparatus which consists of a wrist supported radio frequency (RF) transmitter and a receiver with telephone interface circuit. Upon depressing the button on the transmitter, a RF alarm signal is transmitted to the receiver which is connected to a phone line. The receiver then dials the numbers stored in memory with respect to priority to repeat a pre-recorded message conveying the nature of the alarm. This system confines the user to a limited range. The RF transmitter must be in close range for its signal to be picked up by the relay station connected to the phone line. The system also does not convey any information on the individual's location and requires a call-back. Personal security systems rapidly evolved with the introduction of cellular communications network (CCN) and global positioning system (GPS).

U.S. Pat. No. 5,742,233 issued to Hoffman et al. disclosed a personal security system that tracks the individual in event of emergency. The disclosed system utilizes GPS or alike system to transmit location coordinates to a central dispatch station. It possesses a few advantages over prior arts such as applications in widespread geographical areas, longer battery life, and precise location etc. . . . Their system allows a central dispatch station to activate two-way voice communications which is departs from the proposed invention. They stressed that the portable unit should be worn under the individual's clothes to avoid visibility to the perpetrator. However, in a kidnapping situation, the perpetrator will find the device and will simply toss it aside rendering the system useless. The disadvantage of this and other similar systems is that their designs and appearances explicitly give away their nature of being security devices.

U.S. Pat. No. 5,771,001 issued to Cobb discloses a personal alarm system that detects biological emergency of a person. The system monitors blood pressure, pulse and temperature. In event of emergency, the transmitter sends a signal to the home receiver through cellular relay stations. The home receiver display relevant information such as blood pressure, pulse, temperature and geographical location of the individual. The disclosed system has some advantages but still possesses drawbacks. The system relies heavily on the presence of someone at the receiving end to contact the proper authorities.

U.S. Pat. No. 5,808,564 issued to Simms et al. discloses an automated personal security system with remote activation. The system introduces novel features over prior arts such as U.S. Pat. Nos. 3,568,161, 3,683,114, 4,428,057, 4,596,988, 4,651,157 and 4,904,983. Simms et al. discloses a personal security system that relies on a vehicle to contact a central station. Their system is essentially an automotive tracking system with the addition of remote activation and protection for the passenger(s). Utilizing a vehicle as a transmitter has several advantages such as high signal propagation due to the increased available power supply provided by the vehicle. However, it still possesses many drawbacks such as the range issue. The user has to be within range of the vehicle to transmit an emergency signal. While their system may be effective against carjacking it is useless in dangerous situations such as abduction. In abduction and other similar emergency, the victim is usually remote from the vehicle and even if the alarm was successfully transmitted and authority was dispatched, the victim is not likely to be rescued. Simms et al. also discloses a system that allows a central dispatch station to remotely control the vehicle to sound the horn, illuminate headlights, and to emit electromagnetic, visual or audible signals to assist in locating the vehicle.

U.S. Pat. No. 5,838,237 issued to Revell et al. discloses a personal alarm system that utilizes differential global positioning system (DGPS) to locate the user in emergency events. Their system introduces a novel method of transmitting GPS signals over a cellular communications network (CCN). Their system also emits VHF signal after contacting a central dispatch station to allow the authority to track the victim in places where cellular signals are out of reach. They mentioned it is simple for an assailant or abductor to confiscate a cellular phone and/or moving the victim to a different location. However, the perpetrator may also confiscate the wrist mounted transmitter disclosed in their patent. Their system allows the user to activate the personal alarm without provoking the assailant. Their method is simply transmitting the alarm signal directly to the central dispatch station with preset information. The transmitter will only transmit limited information such as GPS data, user information, etc. . . . It does not allow the central dispatch station to monitor the situation to obtain additional information when necessary.

U.S. Pat. No. 5,929,761 issued to Van der Laan et al. discloses a personal security system comprising of a remote transmitter, a base unit, a communications network and an alarm monitoring station. The transmitter includes a microphone that primarily used for communication between the central station and the user, not for secretly monitoring the environment around the victim. Their system is primarily designed for monitoring vulnerable individuals such as elderly persons who require supervision of others. Their system was not intended for assisting the individuals in emergency situations such as abductions.

U.S. Pat. No. 5,953,650 issued to Villevieille discloses an improved mobile personal security system comprising of a position determining component such as GPS, a portable radiotelephone and a high power mobile transceiver. When an emergency or a request call is detected, the automotive integrated radiotelephone contacts an emergency-call center and transmits its geographical information. The system possesses emergency sensors such crash sensor, flat tire sensors, etc to assist in automated communication with an emergency-call center. The system provides limited personal security because the user needs to be in the vicinity of the vehicle for the system to function. While the improved mobile personal security system offers some advantages over prior arts, it is still plagued by the same flaws of its predecessors. In a kidnap situation, the perpetrator often moves his victim from her vehicle. Hence, even if an emergency request was successfully transmitted, at best only the victim's vehicle will be located. In other circumstances, the perpetrator might confiscate the portable radiotelephone rendering the victim defenseless. In other situations such as a hostile or duress one, it is preferred to secretly contact an emergency monitoring service (EMS) to avoid aggravating the perpetrator.

U.S. Pat. No. 6,147,611 issued to Otero discloses a personal alarm apparatus for protecting individuals from attackers comprising of microphone, shock sensor, speaker and a central processor. The system can be activated manually or vocally. It possesses built in shock sensor to detect attacks on the user to trigger the alarm. The personal alarm device is concealed by attaching it onto the bra of the female. It may also include a transmitter to activate the car alarm in addition to the portable alarm. Because of its simple design, it can be manufactured and marketed inexpensively.

U.S. Pat. No. 6,285,318 issued to Schoen et al. discloses novel transmit-only geo-location techniques which can be easily integrated into any tracking system. Their techniques provide apparent advantages over prior tracking methods. The micro-miniature beacon can be inexpensive manufactured and integrated to provide many tracking applications such as personal security system.

U.S. Pat. No. 6,294,993 issued to Calaman discloses a system for providing personal security via event detection. The system provides automated contact to an EMS to transmit a prerecorded message corresponding to the emergency event. It also transmits geographic location to the EMS. The system primarily depends on physiological sensors for automated event detection. It also offers many common features such as signal acknowledgement to notify the user that his/her emergency request has been received.

U.S. Pat. No. 6,518,889 issued to Schlager et al. discloses a portable voice-activated personal alarm system. The system includes a GPS receiver, a specific danger sensor, a voice activation circuit, and a radio transmitter. The system can be activated by a distress phrase such as “HELP!” or the danger sensor. When activated, the system transmits GPS data to a local public emergency service. This system lacks many features such as a diagnostic procedure and secretly contacting an EMS.

U.S. Pat. No. 6,438,393 issued to Suuronen discloses an integrated motion detector in a mobile communications device. The apparatus comprises a motion detector for generating a signal representative of the kinetic state of the MCD. The system may be adapted for the use of personal security. When the motion detector detects motionless, for example, an elderly person has fallen and has been hurt the MCD will automatically contact an EMS. Another application of the system is to provide statistics for fitness training. Another function of this particular device is to control other functions and properties of a mobile communications device according to its kinetic state. For example, the ringing sound indicating an incoming call may be turned louder when it has remained motionless. The disclosed system does not provide protection for the individuals in violent crimes.

U.S. Patent Application No. US 2002/0070856 filed by Wolfe discloses a security device for monitoring personal property using a wireless interface to a communication network. The system also presented a method of establishing one way communication to listen to the audible conditions around the security device. The device includes a location identifier such as a beacon signal, GPS or the likes. However, the system is primarily used for monitoring personal property and even if adapted it would not be suitable for personal security.

U.S. Patent Application No. US 2002/0070856 filed by Wheeler et al. discloses a method for requesting and dispatching emergency services to a wireless communications network customer. The communications device may be manually or automatically triggered to transmit an emergency request. It includes shock, temperature, and physiological sensors to trigger the device automatically. Since the design includes automated sensors it is susceptible to false alarms. The system did not provide method for efficient verifications of emergency requests. Sometime when other people are around, an audible alarm is just what the user needs to repel potential attackers instead of wasting emergency dispatch resources that could be reserved for extreme emergencies.

U.S. Patent Application No. US 2002/0070856 filed by Brown et al. discloses a personal alarm device capable of transmitting telephone number for alarm confirmation and inquiry. The system is similar to prior arts in functionality; it transmits an emergency request signal to an emergency monitoring service, which then contacts and dispatches the proper assistance or authorities. This system also includes method for transmitting a telephone number so the EMS can give a call-back confirmation. However, the system has a definite edge over prior personal security systems because it factors in the extreme situations the user may be in. When requesting for emergency service, the user may be in a hostile or duress situation such as abductions, rapes, and assaults. In such events, it is preferred not to aggravate the perpetrator. Their system includes a method of transmitting an emergency service request signal with a duress code. If a duress code is received, the EMS will delay the call-back confirmation for a preset time. However, this preset time is tentative and arbitrarily selected. For any emergency situation, a delay is not only unacceptable but it also endangers the victim. Instead of the delay for duress or aggravated situations, the proposed invention introduces a method of secretly monitoring the environment around the user to avoid exacerbating the situation.

In these respects, the disguised personal security system (DPSS) in a mobile communications device according to the present invention substantially departs from the conventional concepts and designs of the prior art. None of the above inventions and patents, taken either singly or in combination, is seen to describe the instant invention as claimed.

### SUMMARY OF THE INVENTION

The disguised personal security system can be automatically or manually activated to contact an emergency monitoring service and transmit geographical coordinates and conditions of emergency. Accordingly, it is a principal object of the invention to provide a mobile communications device with dual alarm function: audible and silent (secret).

It is another object of the invention to provide a personal security apparatus that can be activated manually or automatically.

It is another object of the invention to provide a personal security system that secretly contacts an EMS to transmit position coordinates.

It is another object of the invention to provide a personal security system that allows an EMS to establish one-way communication for monitoring the environment of the user.

It is a further object of the invention to provide a personal security apparatus consisting of a highly sensitive microphone that can be remotely adjusted to provide the best results.

It is another object of the invention to provide a personal security system that contains a hidden secondary DC power supply and setup menus.

It is a further object of the invention to provide a personal security apparatus to have radio frequency (RF) sensors input to allow easy expansion of sensors.

It is another object of the invention to provide a disguised personal security system in a mobile communications device.

Still, another object of the invention is to provide personal security system allows emergency request cancellation by entering the correct sequence of key presses on the MCD that is configurable.

Yet another object of the invention is to provide a personal security system that may be remotely interrogated by an EMS to run diagnostic procedures.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a woman contacting an EMS using an apparatus according to the present invention.

FIG. 2 is top view showing the hidden menus of the MCD according the instant invention.

FIG. 3a through 3g are illustrations of the “masked” message confirmation according the present invention.

FIG. 4 is a flowchart outlining the steps on requesting service from an EMS of the preferred embodiment of the present invention.

FIG. 5 is a flowchart illustrating steps to activate either audible or silent alarm.

FIG. 6 is a flowchart illustrating the steps of a diagnostic procedure to ensure optimum operations of the personal security system.

FIG. 7 is a block diagram showing the control system of a personal security system with a central processing unit (CPU) connected to various components according to the present invention.

FIG. 8 is an illustration of a remote transmitter for alarm activation according the present invention.

Similar reference characters denote corresponding features consistently throughout the attached drawings.

### DETAILED DESCRIPTION OF THE PREFERRED EMBODIMENTS

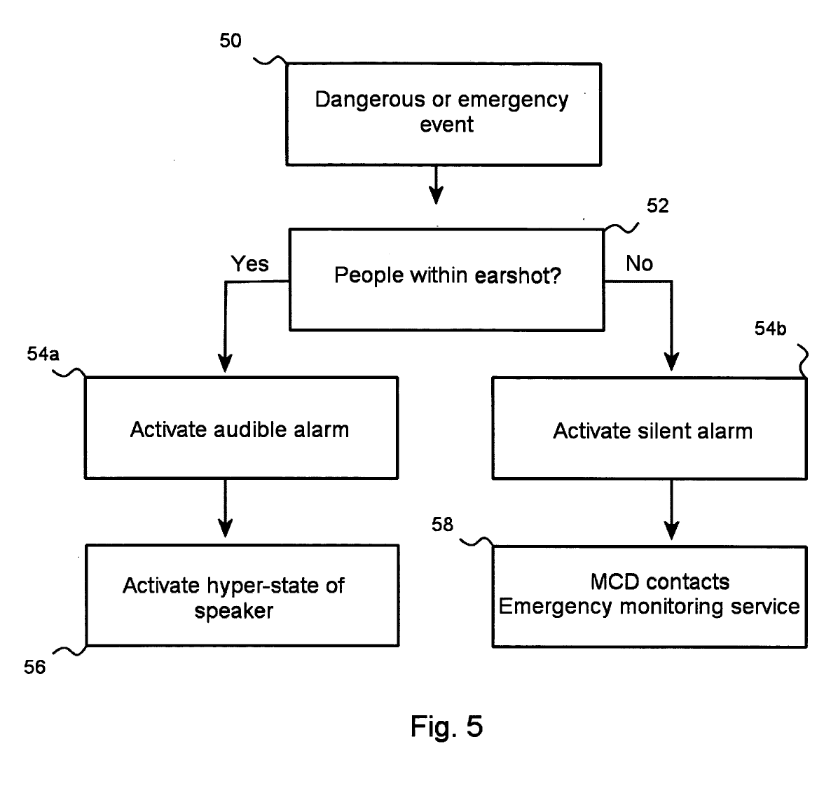

The present invention is personal security system with dual functions: audible (siren-like) and silent (secret) alarm integrated into a mobile communications device (MCD). FIG. 5 illustrates the process of the dual function MCD.

In a first embodiment, the disguised personal security system (DPSS) has two modes of operations. In an emergency event, the user activates the audible alarm when there are people within earshot. Upon triggering the alarm, the MCD activates the speaker into a “hyper-state”, which will create an extremely loud alarm to attract attentions to the user. U.S. Pat. No. 4,554,698 disclosed a unique speaker that produces extremely loud signal suitable for alarm applications. It consists of a piezoelectric transducer which acts as the vibratory medium. The vibrations produced by the transducer are acoustically focused and harmoniously amplified by an acoustic chamber before passing into a reverberation chamber. The chamber increases the amplitude of the sound waves before selectively releasing them to produce the extremely loud alarm signal. The present invention may be implemented using separate speakers, or one with dual functions: one for normal operations and one for alarm; however, any suitable speaker device may be used.

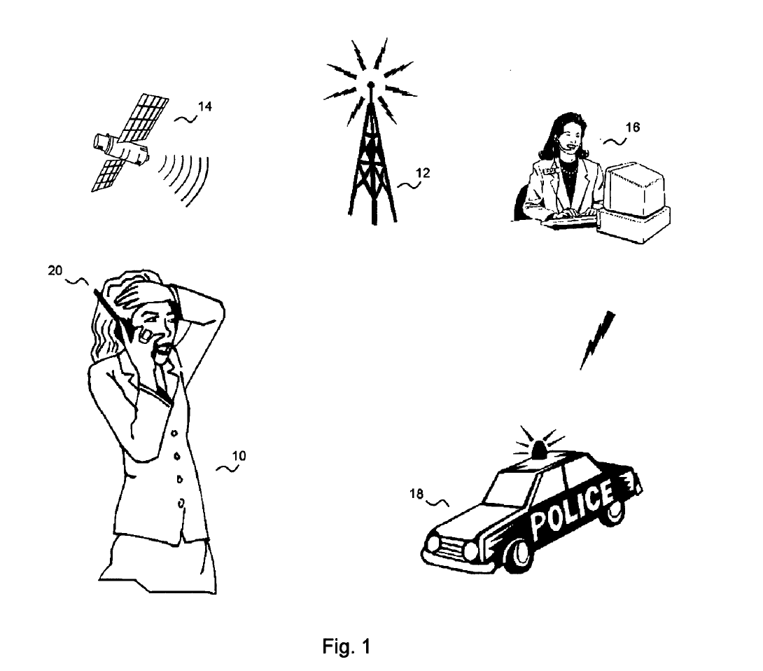

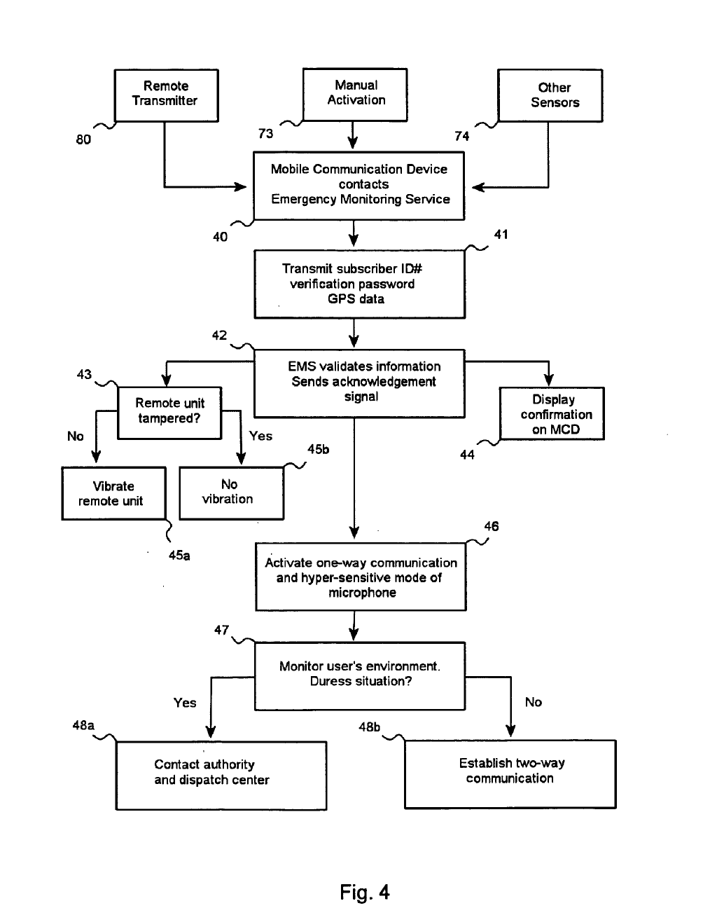

FIG. 1 illustrates a distress user 10 contacts an EMS 16 for assistance using mobile communications device (MCD) 20. FIG. 1 demonstrates operation of the DPSS under light emergency situation such as a car breaking down. The user 10 contacts the operator of an EMS 16 through mobile communications network 12. The operator then requests the geographical location of the user through the use of GPS satellite 14. If required, the operator dispatches the corresponding assistance 18 such as ambulance for medical and police for crimes. FIG. 4 outlines the steps of the preferred embodiment of the present invention.

In event of hostile situation such as gunpoint, assault, abduction, rape, etc. . . . the second mode of operations is preferred. In such hostile or duress events, it is important not to exacerbate the situations by explicitly contacting an emergency monitoring service (EMS). Contacting an EMS will not only aggravate the perpetrator but also minimize the chances of being rescued. If the perpetrator sees attempts to call for help, he will confiscate the personal security system and move the victim to a new location, rendering any rescue efforts futile.

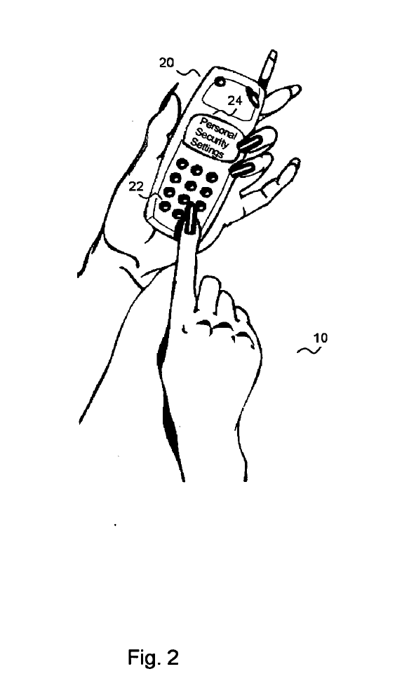

It is desirable for the invention to be marketed with two identical models of the MCD. One model would function normally without the integration of the DPSS. The other model will operate with the novel features of this invention. It should be noted that the model should be as similar as possible so that only the user will know whether it has a personal security system or not. The model number and appearance should be identical. FIG. 2 illustrates the user 10 entering pre-settable secret key sequence 22 to access the hidden menu 24 of MCD 20 to setup preferences for the DPSS.

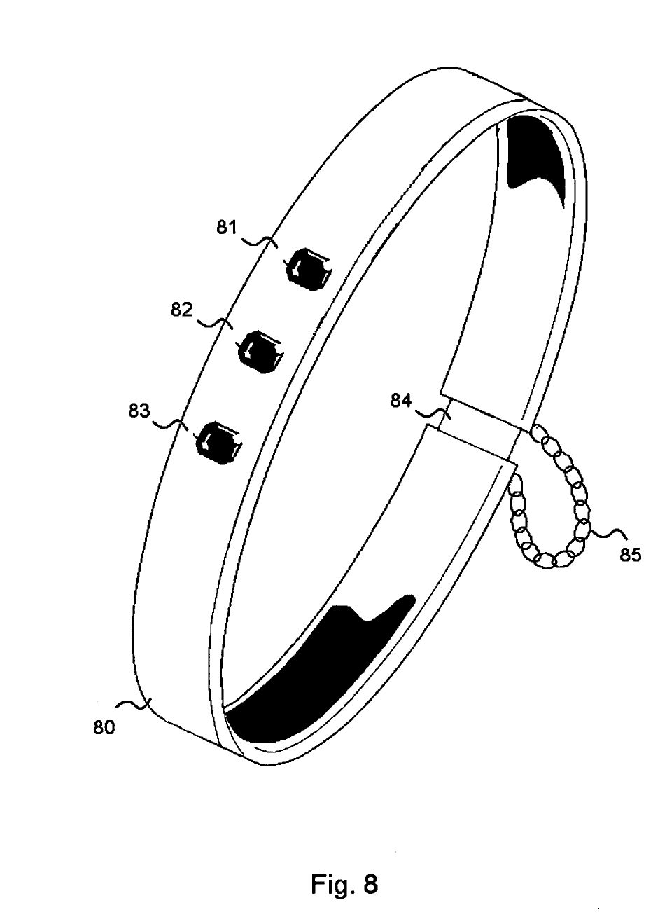

In a hostile situation, the user secretly contacts the EMS 16 by activating the remote transceiver such as the one illustrated as a bracelet 80 in FIG. 8. When activated, the MCD 20 transmits a data packet containing its location coordinates, user information, verification data, and type of emergency. It should be noted that the present invention should not be limited to kind of information it transmit. For example, many other implementations are possible without departing from the essential teaching of this embodiment. For instance, it may transmit medical history of the user as well as other information. However, it is desirable to transmit limited information without hindering the rescue process. For example, medical history and other relevant data maybe stored at EMS 16. The operator can easily access the information by entering the user's unique identification code. Low data transmission also means higher signal propagation and less power consumption. The MCD may be activated manually by a remote unit 80 or automatically through the use of sensors. Remote unit 80 may be a transmit-only unit or a transceiver. Remote transceiver 80 may include a microphone for communication with the EMS through the mobile communication device. The user can trigger the alarm by depressing a pre-settable sequence of buttons 81, 82, and 83 which may be disguised as jewels. However, it is suggested to keep the sequence simple because in distress situation, the user 10 may not remember the correct sequence if it was too complex. By using sequence of buttons, it will eliminate false triggering by accidental depression of the buttons. For instance, when button 81 and 83 but not 82 are depressed, the system can tell it's a legitimate activation. If all three buttons are simultaneously depressed, the system can distinguish it as an accidental activation and ignores it. The system should be able to distinguish the random but rapid depressions as a legitimate trigger. These erratic depressions may correspond to the user 10 panicking in an emergency situation. Alternately, the alarm may be triggered by pulling the on link 85. The clasp 84 may be conductive to serve as a temper-check circuit. Its unauthorized removal may also trigger the alarm. The remote unit 80 may utilizes lithium battery similar to the ones found in watches; however, any suitable power supply may be used.

The disguised personal security system may use shock or physiological sensors to trigger the alarm. It may utilize concealed shock sensor or voice module similar to the one disclosed in U.S. Pat. No. 6,147,611. The shock sensor may be used to detect when the user is attacked or a car crash. The present invention possesses a remote sensors input 74, which allows upgradeability by expansion of remote sensors. Additional sensors may be calibrated by methods similar to television remote control “learning” feature which is well known in the art. It is preferred to for the sensor input 74 to operate at radio frequency (RF) that can be inexpensively and easily implemented. However, it should be noted that any kind of wireless communications such as Bluetooth may be used.

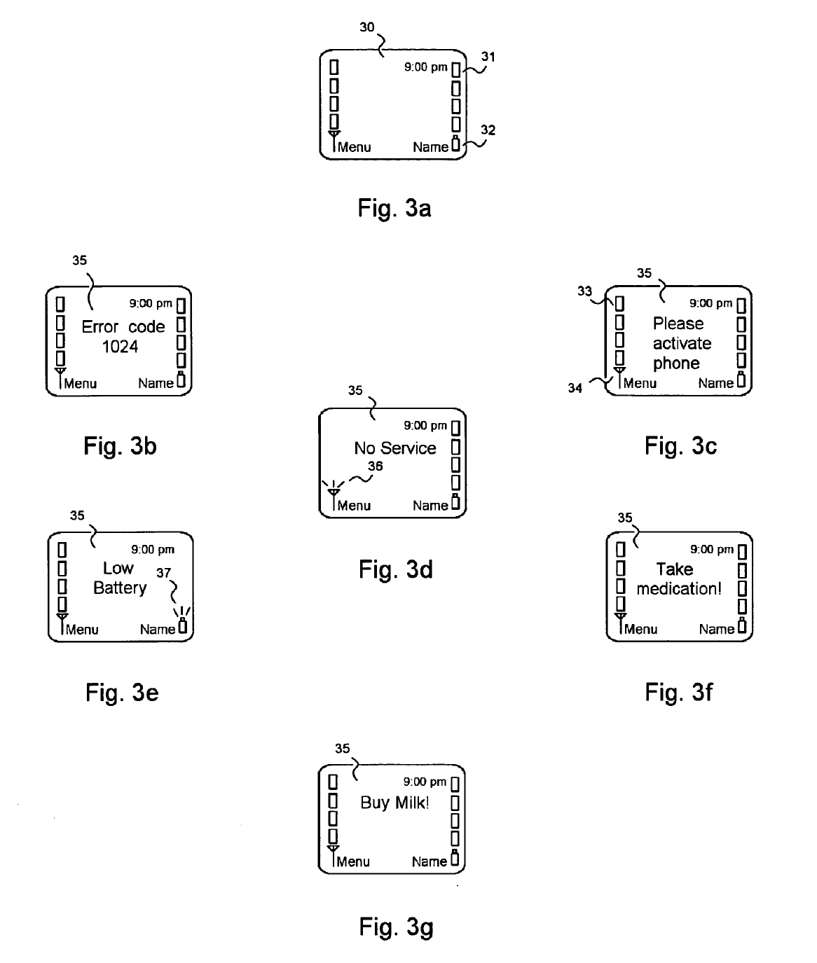

Once the EMS 16 receives the emergency request, it transmits a confirmation signal to the MCD 20 as illustrated in step 42 of FIG. 4. The confirmation signal will only vibrate the remote unit if and only it has not been tampered with. The confirmation signal will also activate the MCD 20 to display the “masked” message 35. FIG. 3a through 3g show variations of the “masked” message 35. The confirmation is disguised as reminder messages in case the MCD 20 is in the hands of the perpetrator. FIG. 3a illustrates the display of MCD 20 during normal operation. The LCD 30 illustrates battery 32 and its meter 31, antenna 34 and signal strength meter 33. FIGS. 3d and 3e display a flashing antenna and battery, respectively. The flashing of these indicators may be followed by an audible signal similar to the tone generated by current MCD when its battery is low. It is preferable to use these methods of confirmation; however, any suitable confirmation method may be used.

After validation of emergency request signal and transmitting a confirmation signal, the EMS 16 establishes one-way communication and activates “hyper-state” of microphone 76. The operator of EMS 16 remotely may remotely adjust microphone 76 to provide efficient surveillance of the user's environment. During this one-way communication, the operator may listens to see whether or not this it is a hostile/duress situation. If not, the operator establishes two-way communication with user 10. The operator may also obtain additional information during the one-way communication mode. For example, the operator may listen to conversations of the perpetrator or background noise that may further assist in the rescue of victim 10.

If required, the operator of EMS 16 dispatches the corresponding assistance or authority 18. When user 10 activates MCD 20, it continuously transmits an emergency request signal until it receives a confirmation signal from EMS 16. It also transmits its location coordinates. The present invention may utilizes any position determination system or method such as LORAN, Direction Finding (DF), Doppler shifts, GPS, time difference of arrival (TDOA) and time of arrival (TOA). The instant invention may be implemented using variations of GPS such as the method of transmitting GPS signals over a cellular communications network (CCN) disclosed in U.S. Pat. No. 5,838,237; however, any suitable geographical positioning system may be used. The MCD 20 may also transmit signal that will allow the authority to locate user 10 quickly and efficiently. It may use VHF or UHF signal to acts as a beacon for the authority/assistance 18 to locate. It may utilize a similar method of VHF or UHF disclosed in U.S. Pat. No. 5,838,237. The present invention may incorporate the micro-miniature beacon transmitting only geo-location proposed in U.S. Pat. No. 6,285,318. The MCD 20 may also emit high bursts of infrared (1R) signal to facilitate the search and rescue operation. It may radiate any form of electromagnetic signal that can be detected and tracked easily; however, any form of beacon or locating signal may be used.

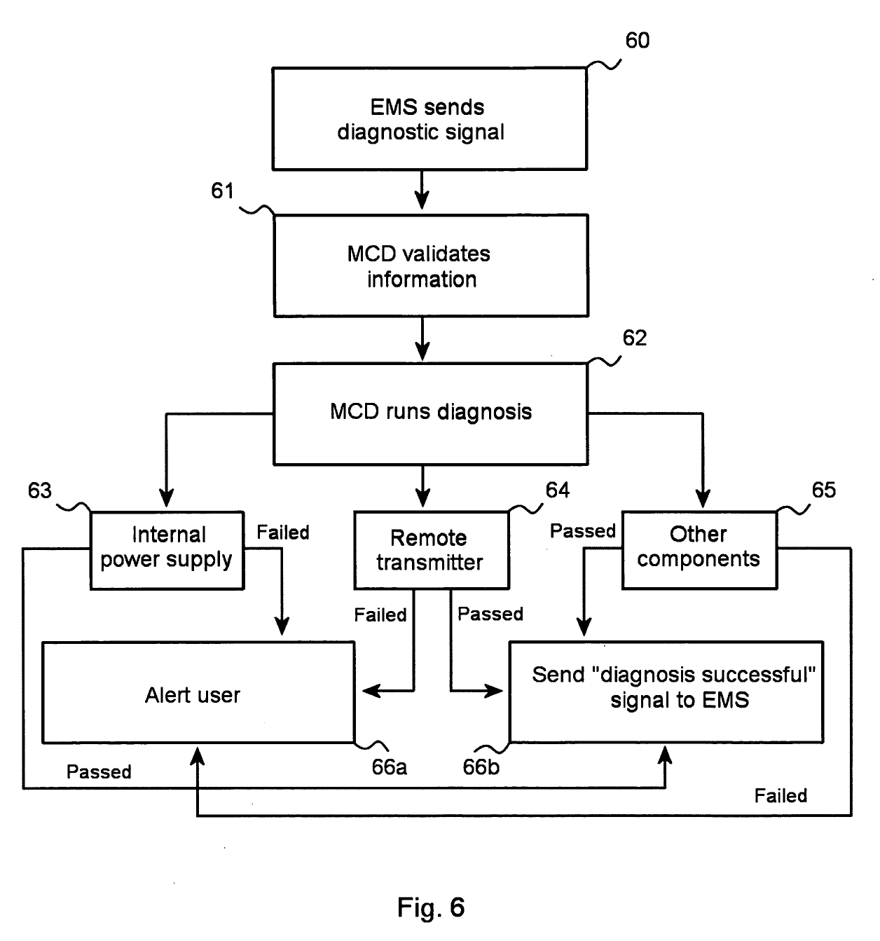

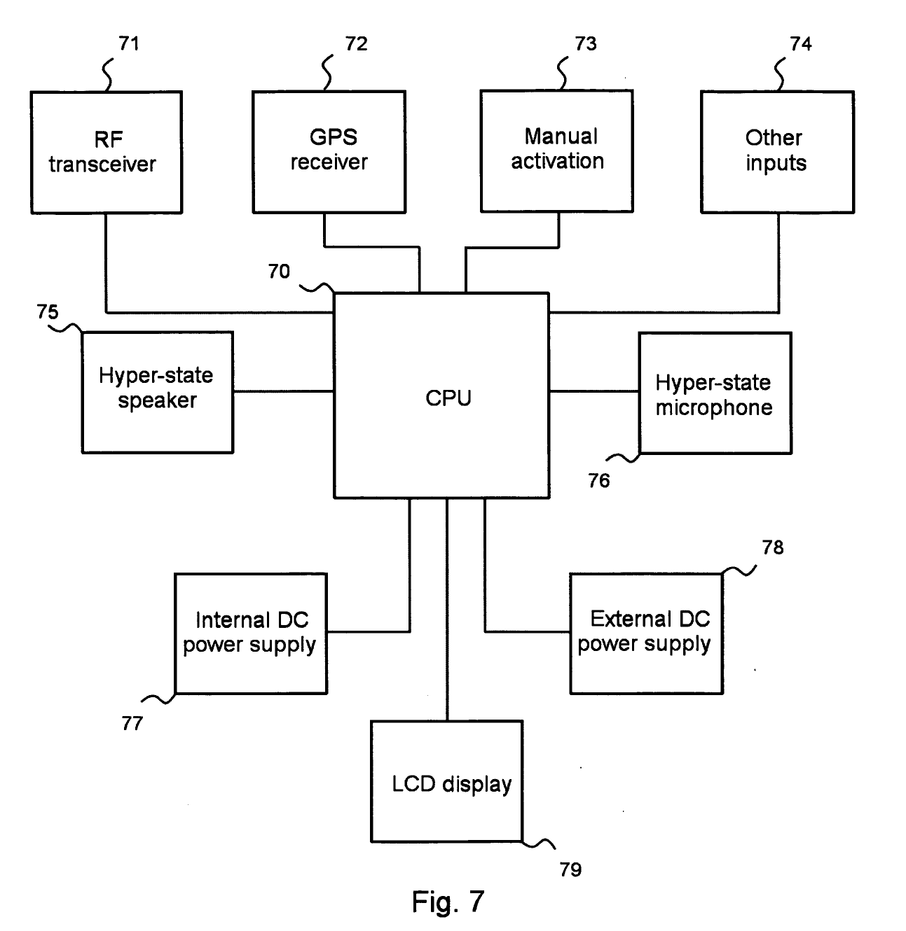

In another embodiment, the MCD 20 possesses a diagnostic feature. It may be remotely or manually activated to begin its diagnostic procedure as illustrated in FIG. 6. The steps outlined in FIG. 6 serve as a basis for diagnostic procedure and should to be construed as limited by the illustration. For example, many variations of the diagnostic procedures can be implemented according the present invention. FIG. 7 is a schematic representation of the connections between the central processing unit (CPU) 70 and major components according the instant invention. CPU 70 may be any type of microprocessor capable of carrying out the operations described in the instant invention. Radio frequency (RF) transceiver 71 acts as a trigger mechanism for the DPSS. It may include a transmit-only or transmit and receive unit. The remote unit bracelet 80 is a RF transceiver. It is capable of transmitting the alarm trigger to the MCD 20 and also receives signals from MCD 20 such as vibration and diagnostic routines. Global positioning system (GPS) receiver 72 provides the geographical coordinates to the CPU 70. It is referenced as GPS receiver, but any location identification system may be used. Manual activation 73 may be implemented as a push button on the MCD 20 or any remote switches. Simple key sequence is also contemplated as another possible implementation of manual activation 73. Other sensors input 74 is a sensors expansion component of MCD 20. It allow user 10 to add any existing or future sensors to act as a trigger mechanism for the DPSS to activate the alarm. To add other sensors, the user simple press the “learn” command on the MCD 20 so that it can accept the sensor's signal. It is analogous to synchronizing a transmitter and a receiver, which is well known in prior art. Hyper-state speaker 75 is a unique speaker capable of generating extremely loud sound for alarm. The hyper-state speaker 75 may be a single speaker with two modes of operation: normal which is used for conversation and hyper-state, for extremely loud alarm that attracts attention to the user. It may be implemented as separate speaker as well. Many other implementations are possible without departing from the essential teaching of this embodiment. For instance another variation of the speaker may have configurable alarm tones. The hyper-state speaker's volume may be adjusted in the hidden menu 24. Hyper-state microphone 76 is a highly sensitive microphone that allows EMS 16 to monitor the environment of user 10. Like the hyper-state speaker 75, the microphone may be a single unit with two modes of operation or two separate units. The hyper-state microphone 76 may be remotely activated and adjusted to provide the best results for the intended purposes. Many other implementations are possible without departing from the essential teaching of this embodiment. For example, to ensure privacy of user 10, MCD 20 needs to validate the request to activate the hyper-state microphone 76. External DC power supply 78 is a removable and rechargeable battery. The common type of such power supply found in mobile communications devices is Ni-MH battery; however, any suitable energy storage device may be used. Internal DC power supply 77 is a hidden power supply. It serves as a backup energy storage device in case the external DC power supply 78 has failed or been removed. For example, a kidnapper confiscates a mobile communications device from his victim and keeps it. It is rare for the perpetrator to discard the victim's mobile communications device because it often expensive and he might have use for it. The victim may also persuade his/her victim keep the confiscated device and remove the external battery. When the external battery 78 is removed, the MCD 20 automatically switches to the internal battery 77 and activates its unique operation mode. It acts as if the mobile communication device has been turned off by turning off its liquid crystal display (LCD) and other components. However, it will continue to transmit its location coordinates and keep the one-way communication opened through the hyper-state microphone 76. The internal power supply 77 may be implemented using rechargeable battery or watch type lithium energy storage; however, any suitable energy storage device may be used.

It is to be understood that the present invention is not limited to the sole embodiments described above, but encompasses any and all embodiments within the scope of the following claims.

1. A disguised personal security system in a mobile communication device, comprising:
a) at least one mean of activating the security system;
b) at least one sensor to detect conditions the user may be subjected to;
c) GPS receiver;

2. The disguised personal security system in a mobile communication device according to claim 1 can be manually or remotely activated.

3. The disguised personal security system in a mobile communication device according to claim 1 has two modes of operations:
a) Normal mode: produces audible alarm
b) Duress mode: operations are secretly carried out.

4) The disguised personal security system in a mobile communication device in claim 3, wherein said duress mode, secretly contacts an emergency monitoring center to transmit position coordinates and relevant data.

5) The disguised personal security system in a mobile communication device according to claim 1, allows an emergency monitoring center to establish one-way communication for monitoring the environment of the user.

6) A mobile communication device comprising:
a) a hidden rechargeable DC power supply
b) Hidden menus protected by configurable secret key sequence.

7) The disguised personal security system in a mobile communication device according to claim 1, comprising of a speaker with dual functions:
a) a normal state in which it operates at low power;
b) a hyper-state in which it operates at an adjustable, high power sufficient to produce a siren like alarm;

8) The disguised personal security system in a mobile communication device according to claim 1, comprising of a microphone with dual functions:
a) a normal state in which it operates like a regular microphone found in mobile communication device;
b) a hyper-state in which it operates in a highly sensitive mode;

9) The sensitivity of the dual state microphone device according to claim 8, can be remotely adjusted by an operator.

10) The disguised personal security system in a mobile communication device according to claim 1, further comprises:
a) a programmable wireless transceiver that allows additional sensors to be added by simple synchronization.

11) The disguised personal security system operating in duress mode according to claim 3, comprising:
a) Masked confirmations of the transmitted emergency signals;
b) All unnecessary functions such as LCD and lights are turned off to ensure secret operations and minimal power consumption;

12) The masked confirmations according to claim 11, comprising:
a) Messages that are understood exclusively by the user
b) Vibration of the mobile communication device.

13) The disguised personal security system in a mobile communication device according to claim 1 can be remotely activated to run diagnostic procedures.

14) The disguised personal security system in a mobile communication device according to claim 1, operates on its hidden power source when the external battery is removed.

15) The disguised personal security system in a mobile communication device according to claim 1, further comprising a configurable secret key sequence that transmit an emergency request cancellation signal.
